(19) United States
(12) Patent Application Publication
(10) Pub. No.: US 2006/0225594 A1
(43) Pub. Date: Oct. 12, 2006

(54) Method and apparatus for positioning printing plates on cylinders of a press

(75) Inventor: August Thoma, Bonstetten (DE)

Correspondence Address: CROWELL & MORING LLP;INTELLECTUAL PROPERTY GROUP, P.O. BOX 14300, WASHINGTON, DC, 20044-4300, US

(73) Assignee: MAN Roland Druckmaschinen AG, Augsburg (DE)

(21) Appl. No.: 11/386,250

(22) Filed: Mar. 22, 2006

(30) Foreign Application Priority Data
Mar. 23, 2005 (DE) 10 2005 013 360.6

(51) Int. Cl. B41F 1/34

(52) U.S. Cl. 101/485

(57) ABSTRACT

A method and apparatus for positioning printing plates on cylinders of a press are disclosed. According to the invention, the method comprises at least the following steps: a) providing a printing plate encoded with a printing plate code and to be positioned on a plate cylinder; b) reading the printing plate code from the printing plate to be positioned at a reading device belonging to the press; c) automatically displaying the plate cylinder of a printing unit of the press and the position on the plate cylinder for the printing plate to be positioned; and d) automatically rotating the plate cylinder into a position suitable for clamping the printing plate on the plate cylinder.

This application claims the priority of German Patent Document No. 10 2005 013 360.6, filed Mar. 23, 2005, the disclosure of which is expressly incorporated by reference herein.

### BACKGROUND AND SUMMARY OF THE INVENTION

The invention relates to a method and apparatus for positioning printing plates on cylinders of a press.

In web-fed rotary presses, an increasing trend can be detected to the effect that an increasing number of printing plates are being positioned on the plate cylinders of the web-fed rotary presses. For example, it is already known to arrange up to twelve printing plates on a plate cylinder, six printing plates then being positioned beside one another in the axial direction of the plate cylinder and in each case two printing plates being positioned one after another in the circumferential direction on the plate cylinders. If, moreover, account is taken of the fact that web-fed rotary presses for multi-color and two-sided printing a plurality of printing material webs have a large number of printing units and therefore a large number of plate cylinders, it follows directly that a large number of printing plates have to be arranged and clamped on the plate cylinders of a web-fed rotary press. In the process, a printer who performs the printing plate positioning on the basis of written production plans can easily lose the overview and either position a printing plate on a completely wrong plate cylinder or arrange it on the correct plate cylinder but at a wrong position on the same.

Taking this as a starting point, the present invention is based on the object of providing a novel type of method and apparatus for positioning printing plates on cylinders of a press.

According to the invention, the method comprises at least the following steps: a) providing a printing plate encoded with a printing plate code and to be positioned on a plate cylinder; b) reading the printing plate code from the printing plate to be positioned at a reading device belonging to the press; c) automatically displaying the plate cylinder of a printing unit of the press and the position on the plate cylinder for the printing plate to be positioned; and d) automatically rotating the plate cylinder into a position suitable for clamping the printing plate on the plate cylinder.

With the method according to the invention for positioning printing plates on cylinders of a press, erroneous fitting and erroneous positioning of printing plates on a web-fed rotary press are reliably avoided. Thus, a printer is shown not only the correct plate cylinder on which a printing plate to be positioned is to be clamped but also the position of the printing plate on the same. Furthermore, the plate cylinder is rotated into a position suitable for clamping the printing plate, which is advantageous in particular when a plurality of printing plates are arranged one after another as seen in the circumferential direction on a plate cylinder. Erroneous fitting of printing plates on web-fed rotary presses can be avoided reliably in this way.

According to an advantageous development of the invention, when a printing plate is already clamped at the position for the printing plate to be positioned, the already clamped printing plate is automatically prepared for a change with the printing plate to be positioned.

### BRIEF DESCRIPTION OF THE DRAWINGS

Preferred developments of the invention emerge from the following description. An exemplary embodiment of the invention, without being restricted thereto, will be explained in more detail using the drawings, in which:

FIG. 1 shows a detail from a press in the region of two printing towers and a reading device in a schematic side view;

FIG. 2 shows a plate cylinder of a printing tower in a rolled-out view, together with twelve printing plates; and

FIG. 3 shows a schematic front view of a printing tower.

### DETAILED DESCRIPTION OF THE DRAWINGS

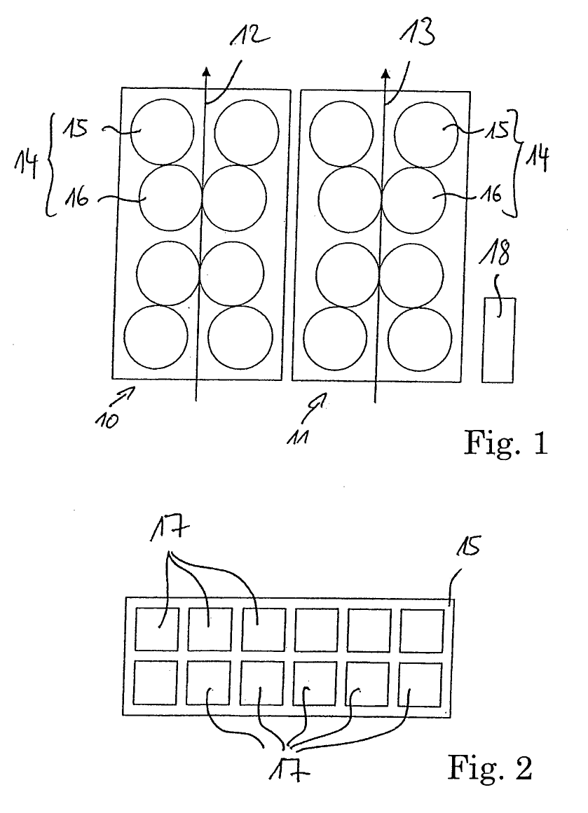

In the following text, the present invention will be described in greater detail with reference to FIGS. 1 to 3.

FIG. 1 shows a schematic detail from a web-fed rotary press in the region of two press units 10 and 11 constructed as printing towers, a web printing material 12 and 13 being printed on both sides in each of the press units 10 and 11. Each of the printing unit towers 10 and 11 has a total of four printing units 14, in each case only the plate cylinder 15 and transfer cylinder 16 of the printing units 14 being illustrated. It should be pointed out that the illustration of FIG. 1 is purely exemplary and, of course, a plurality of such press units can be arranged above one another and beside one another.

In the following text, it is to be assumed that, on each of the plate cylinders 15, six printing plates 17 are positioned beside one another in the axial direction and in each case two printing plates 17 are positioned one after another in the circumferential direction. FIG. 2 shows a plate cylinder 15 together with the printing plates 17 in a rolled-out illustration. In the exemplary embodiment shown, accordingly, the plate cylinders are designed as 6/2 plate cylinders, as they are known, which means that six printing plates are arranged beside one another in the axial direction and in each case two printing plates are arranged after one another in the circumferential direction on a plate cylinder 15.

In the press units 10 and 11 illustrated in FIG. 1, which each comprise four printing units and therefore four plate cylinders 15, this would mean that a total of ninety-six printing plates 17 are positioned on the plate cylinders 15 illustrated.

Now, in order to avoid erroneous positioning or erroneous fitting of printing plates 17 on the plate cylinders 15, within the meaning of the present invention a method for positioning printing plates on plate cylinders is provided in which printing plates 17 which are encoded with a printing plate code are used. Before the fitting of the press with such a printing plate 17, the printing plate code of the printing plate 17 is read at a reading device 18 of the press (see FIG. 1). The reading device 18 can in this case automatically determine the position of the printing plate 17 to be positioned on the basis of a production scheme stored in the reading device 18 or on the basis of a production scheme for the press provided by a control device, not illustrated, that is to say on the one hand determine the plate cylinder 15 and on the other hand determine the position on this plate cylinder 15.

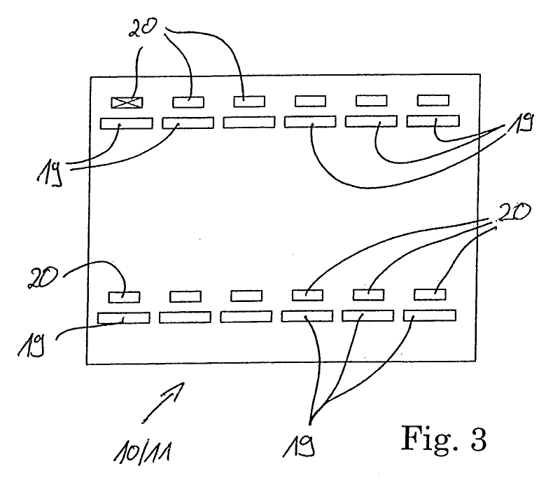

Now, it is within the meaning of the present invention to display automatically to a printer the position automatically determined for the printing plate 17 to be positioned, specifically preferably directly in the region of the press unit or the plate cylinder 15 on which the printing plate 17 is to be positioned. Thus, FIG. 3 shows a schematic front view of a press unit 10 or 11, six insertion openings 19 for the printing plates 17 being illustrated in the region of each plate cylinder 15, distributed over the axial extent of the latter. Via the insertion openings 19, printing plates 17 can be supplied to the respective plate cylinder 15 in order to be clamped or, in order to change a printing plate 17, can be removed from the respective plate cylinder 15. A display device 20 is positioned in the region of each of these insertion openings 19.

Then, once the position of a printing plate 17 has been determined, the display device 20 which is assigned to the insertion opening 19 via which the respective printing plate 17 can be positioned in the correct position on the appropriate plate cylinder 15 lights up. In FIG. 3, this is the outermost left-hand insertion opening 19, which is positioned in the upper row and is therefore assigned to the upper plate cylinder 15. Furthermore, a number or another identification code can be displayed in clear text for the printer via the display device 20, in order once more to compare a number displayed by the display device 20 with a number on the printing plate 17 before the insertion of the printing plate 17 into the corresponding insertion opening 19.

When the position of the printing plate 17 on a printing plate cylinder 15 has been determined automatically by reading the printing plate code, it is within the meaning of the present invention to rotate the corresponding printing plate cylinder 15 automatically into the position suitable for clamping the printing plate 17 on the same. This is advantageous in particular when, as illustrated in FIG. 2, a plurality of printing plates 17 are to be clamped one after another on the printing plate cylinders 15, as seen in the circumferential direction. It is then possible to ensure automatically that a printing plate 17 is not only positioned correctly on a plate cylinder 15 in the axial position but also in the circumferential position.

It should be pointed out that the printing plates 17 to be positioned preferably have the printing plate code in a non-printing region of the same. The printing plate code can be designed as a bar code or the like. Printing plate code is preferably stored in an RFID tag (radio-frequency identity tag) and can be read via radio. This has the advantage that the printing plate code can also be read when the printing plates 17 have already been clamped on a printing plate cylinder 15.

Alternatively, the printing plates to be positioned can also have the printing plate code in a printing region of the same. This printing plate code in the printing region then has a nature such that, after a specific number of cylinder revolutions, for example after a maximum of ten cylinder revolutions, it is dissolved completely during printing operation. This can be achieved, for example, by the printing plate code being formed from water-soluble ink. Following the dissolution, the printed image is then no longer disrupted by the printing plate code. Such self-dissolving printing plate codes can be designed as a bar code and permit automatic position checking of clamped printing plates via a bar-code reader integrated into the respective printing unit. Furthermore, such a design of printing plate codes can be implemented more cheaply than printing plate codes based on RFID tags.

The method according to the invention for positioning printing plates on plate cylinders of a web-fed rotary press is advantageous in particular when, during continuous production operation of a web-fed rotary press, a printed page is to be updated by replacing the appropriate printing plate. In this case, only the printing plate code is then read at the reading device and, on the basis of a stored production plan, the plate cylinder and the position on the plate cylinder at which the updated printing plate is to be clamped are determined automatically. In this case, the outdated printing plate, which is already clamped on the printing plate cylinder, is then automatically prepared for a change with the updated printing plate to be positioned. The corresponding position is displayed automatically to the printer, so that the printer merely has to remove the outdated printing plate via an insertion opening and to supply the updated printing plate via the same insertion opening. Accordingly, by using the invention, a printing plate can be positioned on a plate cylinder in a particularly reliable manner within an extremely short time.

In the case in which a printing plate is already clamped at a position determined for a printing plate to be positioned, an error message can also be generated automatically, specifically when no printing plate change is to be carried out. This would then provide an indication that a printing plate had been wrongly positioned on a printing plate cylinder. In this case, the printing plate code of the printing plate already positioned could then be read via radio in order to establish whether there is erroneous fitting or erroneous positioning.

### LIST OF REFERENCE SYMBOLS

10 Press unit
11 Press unit
12 Printing material
13 Printing material
14 Printing unit
15 Plate cylinder
16 Transfer cylinder
17 Printing plate
18 Reading device
19 Insertion opening
20 Display device

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for positioning printing plates on plate cylinders of a press, comprising the steps of:
a) providing a printing plate encoded with a printing plate code and to be positioned on a plate cylinder;
b) reading the printing plate code from the printing plate to be positioned at a reading device belonging to the press;
c) automatically displaying the plate cylinder of a printing unit of the press and a position on the plate cylinder for the printing plate to be positioned; and
d) automatically rotating the plate cylinder into a position suitable for clamping the printing plate on the plate cylinder.

2. The method according to claim 1, wherein the printing plate has the printing plate code in a non-printing region.

3. The method according to claim 1, wherein the printing plate code is stored in an RFID tag (radio-frequency identity tag) and is read from the RFID tag via radio.

4. The method according to claim 1, wherein the printing plate has the printing plate code in a printing region.

5. The method according to claim 4, wherein the printing plate code dissolves completely after a specific number of cylinder revolutions.

6. The method according to claim 1, wherein the printing plate code is read outside the printing unit of the press before positioning the printing plate.

7. The method according to claim 1, wherein when a printing plate is already clamped at the position for the printing plate to be positioned, an error message is automatically generated.

8. The method according to claim 1, wherein when a printing plate is already clamped at the position for the printing plate to be positioned, the already clamped printing plate is automatically prepared for a change with the printing plate to be positioned.

9. The method according to claim 1, wherein the reading device automatically determines the position of the printing plate to be positioned on a basis of a production scheme for the press.

10. A press, having at least one press unit comprising a plurality of printing units for printing a printing material, wherein a control device carries out the method of claim 1.

11. A method for positioning a printing plate on a plate cylinder of a press, comprising the steps of:
encoding a printing plate code on the printing plate;
reading the printing plate code from the printing plate by a reading device;
displaying a plate cylinder and a position on the plate cylinder for positioning the printing plate; and
rotating the plate cylinder in response to the reading of the printing plate code.

12. The method according to claim 11, wherein the step of displaying the plate cylinder and the position on the plate cylinder includes the step of lighting a display device associated with an insertion opening of the press.

13. The method according to claim 12, further comprising the step of comparing an identification code displayed on the display device to an identification code provided on the printing plate.

14. The method according to claim 11, further comprising the step of storing a production plan for the press in the reading device.

15. An apparatus for positioning a printing plate on a plate cylinder of a press, comprising:
a printing plate, wherein a printing plate code is encoded on the printing plate;
a reading device, wherein the reading device reads the printing plate code from the printing plate; and
a display device for displaying a plate cylinder and a position on the plate cylinder for positioning the printing plate in response to the read printing plate code.

16. The apparatus according to claim 15, wherein the display device is associated with an insertion opening of the press.

17. The apparatus according to claim 15, wherein the display device displays an identification code and wherein an identification code is provided on the printing plate.

18. The apparatus according to claim 15, wherein a production plan for the press is stored in the reading device.

19. The apparatus according to claim 15, wherein the printing plate code is stored in an RFID tag.

20. The apparatus according to claim 15, wherein the printing plate code is a bar code.
